(19) United States
(12) Patent Application Publication
(10) Pub. No.: US 2018/0372428 A1
(43) Pub. Date: Dec. 27, 2018

(54) COMPONENT INCLUDING SURFACE-MODIFIED ARTICLE AND METHOD OF MODIFYING AN ARTICLE

(71) Applicant: GENERAL ELECTRIC COMPANY, Schenectady, NY (US)

(72) Inventor: Dechao LIN, Greer, SC (US)

(21) Appl. No.: 15/631,158

(22) Filed: Jun. 23, 2017

(51) Int. Cl. F28F 13/12; F28F 13/18

(52) U.S. Cl. CPC F28F 13/12; B23K 26/0078; F28F 13/185

(57) ABSTRACT

A method of modifying an article includes welding a plurality of weld rows of weld beads on a surface of the article such that a gap is formed between each pair of neighboring weld rows. The method optionally includes welding a plurality of fill rows of fill beads on the surface of the article such that each fill row of the plurality of fill rows fills at least a portion of one of the gaps. The weld rows and the fill rows increase a thickness of the article at the surface, provide an uneven contour of the article, and operate as turbulators on the surface of the article. A component includes an article having a surface and a plurality of weld rows of weld beads on the surface of the article arranged such that a gap is formed between each pair of neighboring weld rows.

### FIELD OF THE INVENTION

The present embodiments are directed to methods of welding and articles modified by welding. More specifically, the present embodiments are directed to articles with weld turbulators and methods of providing articles with weld turbulators.

### BACKGROUND OF THE INVENTION

By disrupting the flow of a fluid over a surface, generally by disrupting what would otherwise be laminar flow along the surface into turbulent flow, a turbulator increases the rate of heat exchange between the fluid and the surface. Turbulators are conventionally provided in turbine applications to aid in the cooling of turbine components during service.

A turbulator may be formed in any of a number of different ways, depending on the application, the materials involved, and the contour of the surface. Prefabrication or machining of an article having a surface with one or more turbulators may provide the turbulators with a high degree of precision in their shape and location but may significantly increase the production cost and/or the production time of the article.

Formation of a weld turbulator on a surface by welding after fabrication of the surface may be less costly than prefabrication, but may require more time, allow for less precision in the shape and location of the turbulator, and may be difficult to form for certain surface contours.

Gas turbine combustors use sequential liner cooling to cool the back side of hot gas walls with impingement cooling or convective cooling. Cooling features, such as turbulators, may be provided on the back side of these hot gas walls, but these cooling features must be cast or milled out of a solid piece of metal. This is extremely time consuming, makes providing turbulators on the back side of hot gas walls prohibitively expensive, and limits the placement and shape of the turbulators. Conventional methods only provide straight cooling ribs on the cylindrical part of sequential liners. The complex geometry of the transition piece of a combustor severely limits the ability to provide a turbulator to a transition piece by conventional methods.

### BRIEF DESCRIPTION OF THE INVENTION

In an embodiment, a method of modifying an article includes welding a plurality of weld rows of weld beads on a surface of the article such that a gap is formed between each pair of neighboring weld rows of the plurality of weld rows. The method optionally includes welding a plurality of fill rows of fill beads on the surface of the article such that each fill row of the plurality of fill rows fills at least a portion of one of the gaps. The weld rows and the fill rows increase a thickness of the article at the surface, provide an uneven contour of the article, and operate as turbulators on the surface of the article.

In another embodiment, a component includes an article having a surface and a plurality of weld rows of weld beads on the surface of the article arranged such that a gap is formed between each pair of neighboring weld rows of the plurality of weld rows. The component optionally includes a plurality of fill rows of fill beads on the surface of the article arranged such that each fill row of the plurality of fill rows fills at least a portion of one of the gaps. The weld rows and the fill rows increase a thickness of the article at the surface, provide an uneven contour of the article, and operate as turbulators on the surface of the article.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic side view in a plane perpendicular to the weld direction of a welded article substrate with three weld beads in an embodiment of the present disclosure.

FIG. 2 is a schematic side view of the welded article of FIG. 1 with a fill bead between two of the weld beads.

FIG. 3 is a schematic cross sectional view of a combustor with a unibody component in an embodiment of the present disclosure.

FIG. 4 is a schematic cross sectional view of the unibody component of FIG. 3.

FIG. 5 is a schematic cross sectional view of a liner and a separate transition piece in an embodiment of the present disclosure.

FIG. 6 is a schematic cross sectional view of a combustor with the liner and separate transition piece of FIG. 5.

FIG. 7 is a schematic side view of a portion of a completed welded article in an embodiment of the present disclosure.

FIG. 8 is a top view of the welded article of FIG. 7 of alternating weld rows and fill rows forming the weld area on the substrate.

Wherever possible, the same reference numbers will be used throughout the drawings to represent the same parts.

### DETAILED DESCRIPTION OF THE INVENTION

Provided are articles with weld turbulators and methods of providing articles with weld turbulators.

Embodiments of the present disclosure, for example, in comparison to concepts failing to include one or more of the features disclosed herein, increase the metal thickness of an article, a component, a liner of a turbine combustor, or a transition piece of a turbine combustor; increase a rate of heat transfer between a surface and a fluid flowing along the surface; increase a body stiffness of a transition piece; provide a cooling feature at the outside diameter (OD) surface of a liner; provide a cooling feature at the OD surface of a liner; permit manufacture of a liner, a transition piece, or a unibody component from a thinner sheet of material; increase the cooling on the OD of a transition piece while maintaining the same stiffness as in a conventional transition piece, provide a cost saving due to an easier fabrication with a thinner body, or combinations thereof.

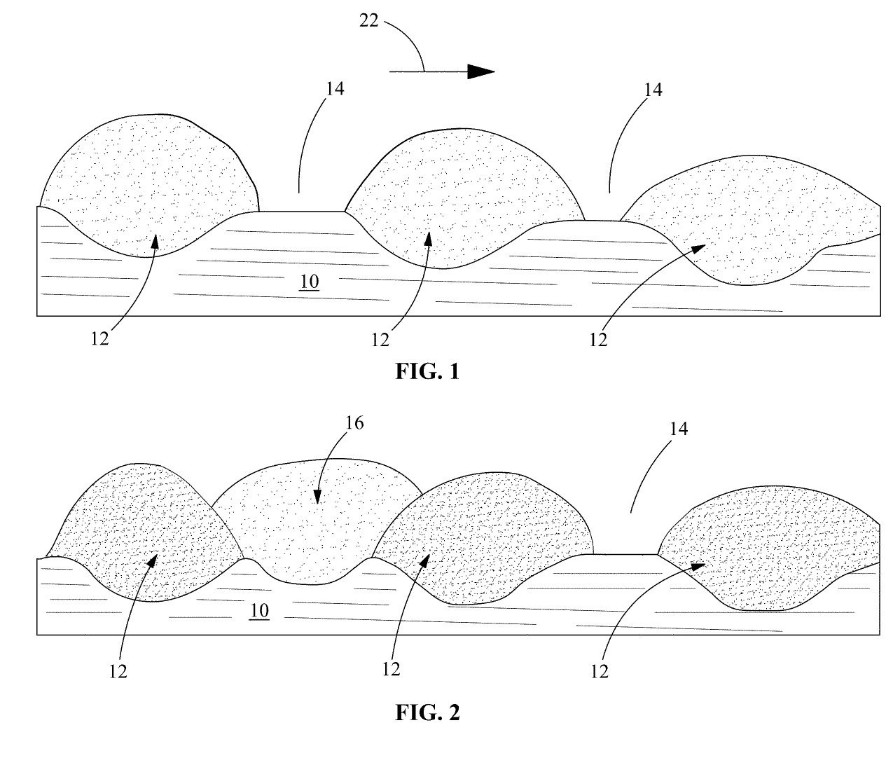

Referring to FIG. 1, weld rows 12 of weld beads are non-overlappingly welded to the surface 20 of an article 10 so that there are gaps 14 between the weld rows 12. Each weld row 12 may be non-uniform, uniform, or substantially uniform in shape along the length of the weld row 12. The weld rows 12 may be applied to the article 10 with a predetermined uniform weld row spacing between each pair of neighboring weld rows 12 such that the gap 14 formed between a pair of weld rows 12 is a channel of a substantially uniform width. The weld rows 12 change the surface contour of the article 10 from a substantially smooth contour to an uneven contour. Thus, each weld row 12 may serve as a weld turbulator to increase the rate of heat transfer between the article 10 and a fluid flowing along the surface 20 of the article 10 in a general flow direction 22 substantially perpendicular to the weld rows 12. The weld rows 12 also increase the thickness of the article 10 at the surface 20.

Referring to FIG. 1 and FIG. 2, once the weld rows 12 have been placed, a fill row 16 may be deposited in the gap 14 between a pair of neighboring weld rows 12. Although the fill row 16 is shown with a fill row peak height from the surface 20 of the article 10 that is substantially equal to the weld row peak height, the fill row 16 may alternatively have a fill row peak height that is greater than or less than to the weld row peak height. Each fill row 16 is preferably welded to the article 10 and the neighboring weld rows 12 with complete fusion without overlapping of neighboring fill rows 16. The weld rows 12 and the fill rows 16 increase a thickness of the article 10 at the surface 20. The article 10 may be any article 10 in need of an increase in thickness, an uneven contour, or turbulators on the surface 20 of the article 10.

In some embodiments, the article 10 is a turbine component. In some embodiments, the material of the article is a superalloy. In some embodiments, the superalloy is an iron-based superalloy, a cobalt-based superalloy, or a nickel-based superalloy.

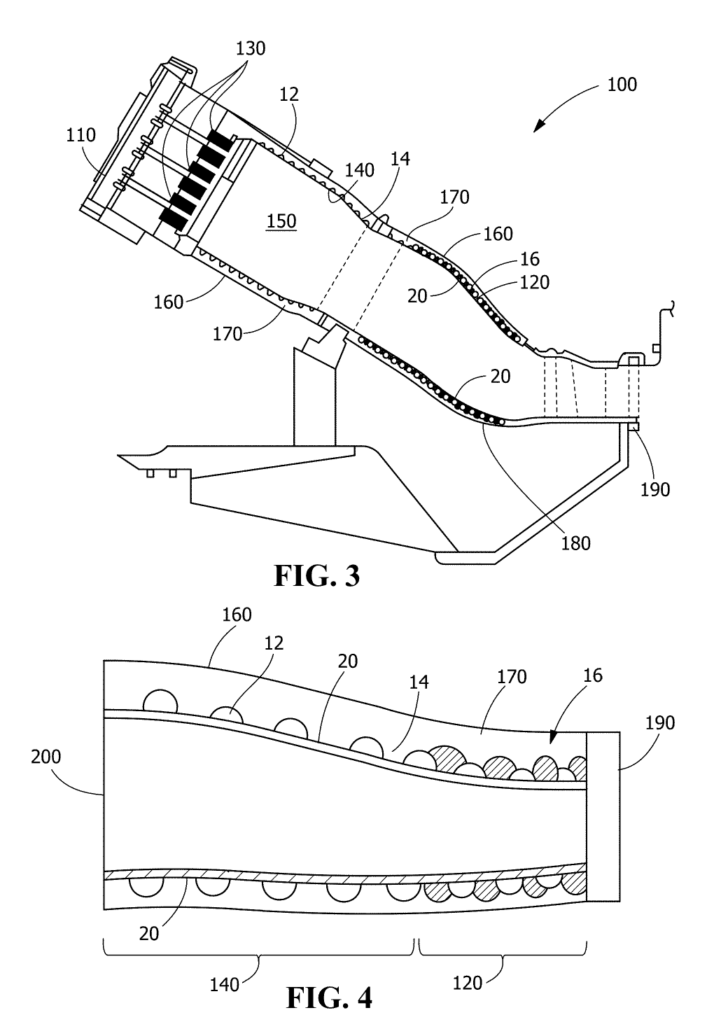

In some embodiments, the article 10 is a portion of a gas turbine combustor. Referring to FIG. 3, the combustor 100 extends from an end cover 110 at a head end to an aft frame 190 at an aft end of the combustor 100. Fuel nozzles 130 are positioned about the end cover 110. A liner 140 extends from the fuel nozzles 130 toward a transition piece 120 and defines a pressurized combustion zone 150. The liner 140 and the transition piece 120 are formed as a unibody component 180. The unibody component 180 is surrounded by a flow sleeve 160. The surface 20 and the flow sleeve 160 define a flow path 170 therebetween for the flow of cooling fluid from the compressor or from other sources. More than one combustor 100 may be used in a gas turbine, arranged, for example, in a can annular array. The surface 20 of the liner 140 and the transition piece 120 include weld rows 12 and fill rows 16 that are better seen in FIG. 4.

Referring to FIG. 4, a method of modifying the surface 20 of the liner 140 and the transition piece 120 includes welding weld rows 12 of weld beads on the outer surface 20 of the liner 140 and the transition piece 120 such that a gap 14 is formed between each pair of neighboring weld rows 12. The weld rows 12 are spaced on the surface 20 along most of the length or substantially along the entire length of the flow path 170 from the head end 200 of the liner 140 to the aft frame 190 of the transition piece 120 at the aft end of the combustor 100. The gaps 14 on the surface 20 of the transition piece 120 may be wider, narrower, or of the same width as the gaps 14 on the surface 20 of the liner 140. The method optionally includes welding a plurality of fill rows 16 of fill beads on the surface 20 such that each fill row 16 fills at least a portion of one of the gaps 14. Although the fill rows 16 are shown with a fill row peak height from the surface 20 that is greater than the weld row peak height, the fill rows 16 may alternatively have a fill row peak height that is substantially equal to or less than to the weld row peak height by adjusting the amount of weld material applied to the gap 14. In FIG. 4, the fill rows 16 fill all of the gaps 14 on the transition piece 120 but not on the liner 140. In some embodiments, there may be fill rows 16 in none, one, some, or all of the gaps 14 on the surface 20 of the transition piece 120. In some embodiments, there may be fill rows 16 in none, one, some, or all of the gaps 14 on the surface 20 of the liner 140. The weld rows 12 and the fill rows 16 increase a thickness at the surface 20, provide an uneven contour at the surface 20, and operate as turbulators on the surface 20.

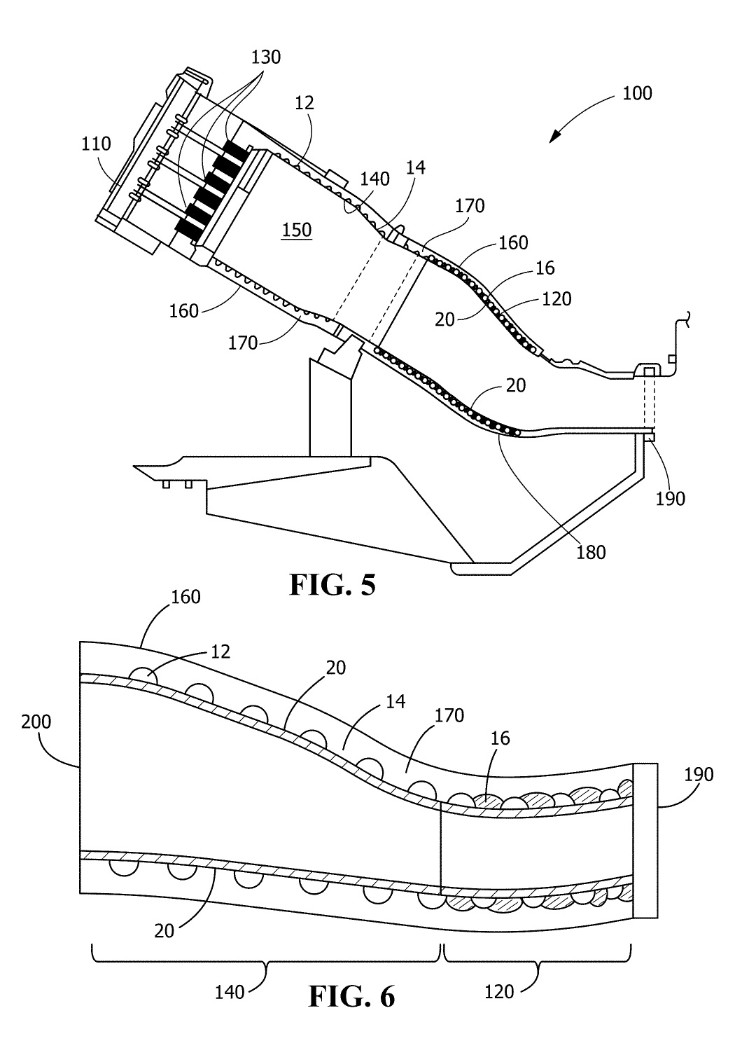

Referring to FIG. 5, the combustor 100 extends from an end cover 110 at a head end to an aft frame 190 at an aft end of the combustor 100. Fuel nozzles 130 are positioned about the end cover 110. A liner 140 extends from the fuel nozzles 130 toward a transition piece 120 and defines a pressurized combustion zone 150. The liner 140 and the transition piece 120 are formed separately and are joined to each other on complementary ends. The liner 140 and the transition piece 120 are surrounded by a flow sleeve 160. The surface 20 and the flow sleeve 160 define a flow path 170 therebetween for the flow of cooling fluid from the compressor or from other sources. More than one combustor 100 may be used in a gas turbine, arranged, for example, in a can annular array. The surface 20 of the liner 140 and the transition piece 120 include weld rows 12 and fill rows 16 that are better seen in FIG. 6.

Referring to FIG. 6, a method of modifying the surfaces 20 of the liner 140 and the transition piece 120 includes welding weld rows 12 of weld beads on the outer surface 20 of the liner 140 such that a gap 14 is formed between each pair of neighboring weld rows 12. The method also includes welding weld rows 12 of weld beads on the outer surface 20 of the transition piece 120 such that a gap 14 is formed between each pair of neighboring weld rows 12. The weld rows 12 are spaced on the surfaces 20 along most of the length or substantially along the entire length of the flow path 170 from the head end 200 of the liner 140 to the aft frame 190 of the transition piece 120 at the aft end of the combustor 100. The gaps 14 on the surface 20 of the transition piece 120 may be wider, narrower, or of the same width as the gaps 14 on the surface 20 of the liner 140. The method optionally includes welding a plurality of fill rows 16 of fill beads on the surface 20 of the transition piece 120 such that each fill row 16 fills at least a portion of one of the gaps 14. The weld rows 12 and the fill rows 16 may be placed either before or after the liner 140 and the transition piece 120 are joined. Although the fill rows 16 are shown with a fill row peak height from the surface 20 that is substantially equal to the weld row peak height, the fill rows 16 may alternatively have a fill row peak height that is greater than or less than to the weld row peak height by adjusting the amount of weld material applied to the gap 14. In FIG. 6, the fill rows 16 fill all of the gaps 14 on the transition piece 120 but not on the liner 140. In some embodiments, there may be fill rows 16 in none, one, some, or all of the gaps 14 on the surface 20 of the transition piece 120. In some embodiments, there may be fill rows 16 in none, one, some, or all of the gaps 14 on the surface 20 of the liner 140. The weld rows 12 and the fill rows 16 increase a thickness at the surface 20, provide an uneven contour at the surface 20, and operate as turbulators on the surface 20.

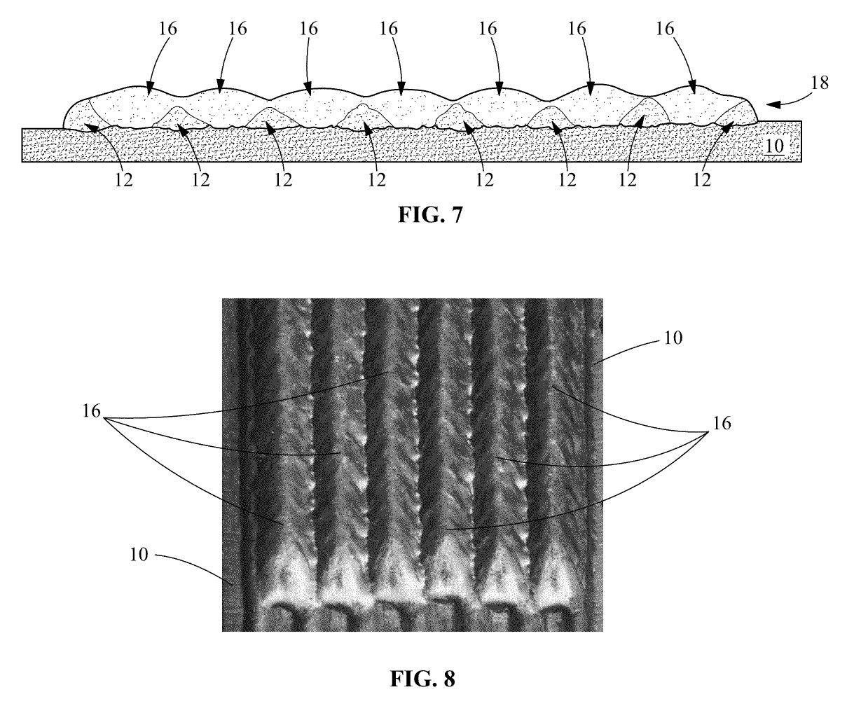

Referring to FIG. 7 and FIG. 8, a weld area 18 is built up by filling all of the gaps 14 between weld rows 12 on the article 10 with fill rows 16. The height of the fill rows 16 may be greater than, less than, or equal to the height of the weld rows 12. In the image of FIG. 8, the weld rows 12 extend past where the fill rows 16 terminate and so are visible at the bottom of the image.

Although the methods disclosed herein may be used to modify any surface 20 in need of an increased thickness at the surface 20, an uneven contour for the surface 20, an increase in the rate of heat transfer between the surface and a fluid flowing along the surface, or turbulators on the surface 20, the methods are particularly advantageous for OD surfaces of a liner 140 and a transition piece 120 of a combustor 100 for a gas turbine engine.

In some embodiments, the present methods permit the initial formation of a liner 140 and a transition piece 120 that are thinner than the existing or conventional components. A conventional liner 140 and a conventional transition piece 120 may be formed from a sheet material as thin as about 4.8 mm (about 0.188″). In some embodiments, the present liner 140 and transition piece 120 are formed from a sheet material having a thickness of less than 4.8 mm (about 0.188″), alternatively about 4.0 mm (about 0.157″), alternatively about 4.0 mm (about 0.157″) or less, alternatively about 3.2 mm (about 0.125″), alternatively about 3.2 mm (about 0.125″) or less, or any value, range, or sub-range therebetween. The thinner sheet provides an easier fabrication of the liner 140 and transition piece 120. In some embodiments, the sheet material is a sheet metal.

In some embodiments, a first welding step adds weld turbulators in the form of weld rows 12 on the OD surfaces 20 of both the liner 140 and the transition piece 120.

In some embodiments, a second welding step adds weld turbulators in the form of fill rows 16 on the OD surface 20 of the transition piece 120 in the gaps 14 between neighboring weld rows 12. In some embodiments, the same welder or same type of welder is used in the first welding as the second welding. In some embodiments, the welder is an arc welder. In some embodiments, the arc welder is a metal inert gas (MIG) welder. In some embodiments, the arc welder is a tungsten inert gas (TIG) welder. In some embodiments, the method provides the weld rows 12 and the fill rows 16 on the transition piece 120 in only about 30 minutes or less.

In some embodiments, the weld turbulators of weld rows 12 on the liner 140 replace machined ones for cost saving. In some embodiments, the weld turbulators of weld rows 12 and fill rows 16 on the transition piece 120 increase the metal thickness, increase the stiffness, and add a cooling feature on the transition piece 120.

In some embodiments, the spacing of the weld rows 12 on the surface 20 of the liner 140 is different than the spacing of the weld rows 12 on the surface 20 of the transition piece 120. In some embodiments, the spacing of the weld rows 12 on the liner 140 is about 7.6 mm (about 0.3″), alternatively in the range of about 6.4 mm (about 0.25″) to about 8.9 mm (about 0.35″), or any value, range, or sub-range therebetween, and the spacing of the weld rows 12 on the transition piece 120 is about 2.5 mm (about 0.1″), alternatively in the range of about 2.0 mm (about 0.08″) to about 3.0 mm (about 0.12″), or any value, range, or sub-range therebetween.

In some embodiments, there is no overlapping of the weld rows 12, which provides a lower heat input into the transition piece 120 to eliminate, reduce, or minimize a welding-induced distortion of the transition piece 120 during the method. In some embodiments, the method forms the weld rows 12 in a non-sequential order. In some embodiments, there is no overlapping of the fill rows 16. In some embodiments, the fill rows 16 provide a rough or uneven OD surface 20 to increase the cooling of the transition piece 120 during service. In some embodiments, the method forms the fill rows 16 in a non-sequential order.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A method of modifying an article comprising:
welding a plurality of weld rows of weld beads on a surface of the article such that a gap is formed between each pair of neighboring weld rows of the plurality of weld rows; and
optionally welding a plurality of fill rows of fill beads on the surface of the article such that each fill row of the plurality of fill rows fills at least a portion of one of the gaps;
wherein the weld rows and the fill rows increase a thickness of the article at the surface, provide an uneven contour of the article, and operate as turbulators on the surface of the article.

2. The method of claim 1, wherein the article comprises a transition piece for a combustor of a gas turbine and the surface is an outer diameter surface of the transition piece.

3. The method of claim 1, wherein the article comprises a liner for a combustor of a gas turbine and the surface is an outer diameter surface of the liner.

4. The method of claim 1, wherein the article is a unibody component of a combustor of a gas turbine, the unibody component comprising a liner and a transition piece integral with the liner, and wherein the surface is an outer diameter surface of the unibody component.

5. The method of claim 4, wherein the weld rows are located on both the liner and the transition piece, and wherein the fill rows are located on the transition piece but not on the liner.

6. The method of claim 1, wherein the welding is by a metal inert gas (MIG) welder.

7. The method of claim 1, wherein the welding is by a tungsten inert gas (TIG) welder.

8. The method of claim 1, wherein the weld rows are non-overlapping and the fill rows are non-overlapping.

9. The method of claim 1, wherein welding the plurality of weld rows comprises welding the plurality of weld rows in a non-sequential order, and welding the plurality of fill rows comprises welding the plurality of fill rows in a non-sequential order.

10. The method of claim 1, wherein the thickness of the article at the surface prior to the modifying is about 3.2 mm or less.

11. The method of claim 1 further comprising forming the article from a sheet of metal.

12. The method of claim 1 further comprising directing a flow of cooling fluid along the uneven contour to cool the article.

13. A component comprising:
an article having a surface;
a plurality of weld rows of weld beads on the surface of the article arranged such that a gap is formed between each pair of neighboring weld rows of the plurality of weld rows; and
optionally a plurality of fill rows of fill beads on the surface of the article arranged such that each fill row of the plurality of fill rows fills at least a portion of one of the gaps;
wherein the weld rows and the fill rows increase a thickness of the article at the surface, provide an uneven contour of the article, and operate as turbulators on the surface of the article.

14. The component of claim 13, wherein the component is a combustor of a gas turbine, the article is a transition piece of the combustor, and the surface is an outer diameter surface of the transition piece.

15. The component of claim 13, wherein the component is a combustor of a gas turbine, the article is a liner of the combustor, and the surface is an outer diameter surface of the liner.

16. The component of claim 13, wherein the component is a combustor of a gas turbine, the article comprises a liner and a transition piece integral with the liner, and the surface is an outer diameter surface of the liner and the transition piece.

17. The component of claim 16, wherein the weld rows are located on both the liner and the transition piece, and wherein the fill rows are located on the transition piece but not on the liner.

18. The component of claim 13, wherein a fill row peak height of the plurality of fill rows is greater than a weld row peak height of the weld rows.

19. The component of claim 13, wherein the weld rows are non-overlapping and the fill rows are non-overlapping.

20. The component of claim 13, wherein the thickness of the article at the surface without the weld rows and the fill rows is about 3.2 mm or less.
